(19) United States
(12) Patent Application Publication
(10) Pub. No.: US 2007/0065099 A1
(43) Pub. Date: Mar. 22, 2007

(54) Information recording and reproducing apparatus performing special reproduction

(75) Inventor: Yoshikazu Onishi, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/515,595

(22) Filed: Sep. 5, 2006

(30) Foreign Application Priority Data
Sep. 16, 2005 (JP) 2005-270306

(51) Int. Cl. H04N 5/91

(52) U.S. Cl. 386/68

(57) ABSTRACT

A control unit determines whether a command for programmed reproduction or random reproduction is selected and indicated. If the command is selected, the control unit references table-of-contents (TOC) information of a lead-in area stored as management information of a CD, which is an optical disk, and stored at a radially inner portion. The control unit thus obtains an identification number (a track number) of data stored in the CD at a data area. The control unit then causes a display unit to display a program setting screen toward in a memory unit. The control unit then determines whether the user selects setting the programmed reproduction or the random reproduction. In response to such selection being indicated, from normal reproduction, the programmed reproduction or the random reproduction is performed.

### BACKGROUND OF THE INVENTION

1. Field of the Invention

The present invention relates generally to information recording and reproducing apparatuses and particularly to CD/DVD compatible, information recording and reproducing apparatuses capable of recording information on and/or reproducing information from optical disks in the form of a compact disk (CD) and a digital versatile disk (DVD).

2. Description of the Background Art

Conventionally there has been an information recording and reproducing apparatus employing an optical head referred to as an optical pickup to record information on and/or reproduce information from a CD, a DVD or a similar optical disk having an information recording track formed concentrically or spirally. The optical pickup is configured to employ an objective lens to collect a beam of light for example of a semiconductor laser on an optical disk to illuminate the optical disk and is also configured to receive a reflection of the light from the optical disk and output an electrical signal corresponding thereto, and is adapted to move in the radial direction of the optical disk.

The information recording and reproducing apparatus moves the optical pickup to a predetermined position located on the optical disk and rotates the optical disk, while the apparatus collects the light emanating from the optical pickup on a recording track to illuminate the track to record information on and/or reproduce information from the optical disk.

Information stored in the optical disk is reproduced as follows: Initially, the optical pickup outputs light, which is gathered on a surface of the optical disk at a point, or focused thereon (“focus lock-in”), and furthermore, the light thus focused thereon is positioned on a recording track (“track lock-in”). This is done by moving in response to the electrical signal output from the optical pickup the objective lens in a direction perpendicular to the surface of the optical disk and a direction perpendicular to the recording track. With the light thus focused on the disk and positioned on the track, the optical pickup outputs the electrical signal and in accordance therewith a pit formed in the optical disk is detected and information stored in the optical disk is thus read and reproduced. Recording information on the optical disk is done by forming a pit on the optical disk at a recording track with light emanating from the optical pickup and collected on and thus illuminating the optical disk.

The above described operation is a typical operation of an information recording and reproducing apparatus. In recent years, however, the operation is diversified and there also appears an information recording and reproducing apparatus not only having a function of normal recording/reproduction but also having added thereto a function for example of random reproduction or programmed reproduction or other similar special reproduction, as indicated for example in Japanese Patent Laying-Open Nos. 2001-195870 and 2002-190187.

Conventional information recording and reproducing apparatuses, however, generally have a configuration that cannot perform random reproduction or programmed reproduction or similar, special reproduction during normal reproduction and requires that equipment first be stopped from operating before such special reproduction is performed. This prevents a function imparted to the equipment from being utilized efficiently and is thus inconvenient to users.

### SUMMARY OF THE INVENTION

The present invention has been made to overcome such disadvantage as described above and it contemplates an information recording and reproducing apparatus also capable of performing special reproduction during normal reproduction.

In accordance with the present invention an information recording and reproducing apparatus includes reproduction means for reproducing data stored in an information storage medium and a control unit generally controlling the apparatus. The control unit operates in response to a command requesting that the data be reproduced to employ the reproduction means to reproduce data stored in the information storage medium and if during reproduction a command is input requesting that the data be subjected to special reproduction then without receiving a command input requesting that reproduction be stopped the control unit switches to the special reproduction to thus reproduce the data stored in the information storage medium. The special reproduction is one of programmed reproduction and random reproduction. The information storage medium is a compact disk. In response to the command being received requesting that the special reproduction be performed, the control unit obtains table-of-contents information from the information storage medium.

In accordance with the present invention an information recording and reproducing apparatus includes reproduction means for reproducing data stored in an information storage medium and a control unit generally controlling the apparatus. The control unit operates in response to a command requesting that the data be reproduced to employ the reproduction means to reproduce data stored in the information storage medium and if during reproduction a command is input requesting that the data be subjected to special reproduction then without receiving a command input requesting that reproduction be stopped the control unit switches to the special reproduction to thus reproduce the data stored in the information storage medium.

Preferably the special reproduction is one of programmed reproduction and random reproduction.

Preferably the information storage medium is a compact disk.

Preferably in response to the command being received requesting that the special reproduction be performed the control unit obtains table-of-contents information from the information storage medium.

If during reproduction a command is input requesting that data be subjected to special reproduction then without receiving a command input requesting that the reproduction be stopped the present information recording and reproducing apparatus switches to the special reproduction to thus reproduce the data stored in the information storage medium. The present apparatus can switch from normal reproduction to random reproduction or programmed reproduction or similar special reproduction without issuing an instruction to stop, and thus perform such special reproduction. This allows a function to be efficiently utilized to contribute to enhance convenience for users.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing an information reproducing and reproducing apparatus in accordance with an embodiment of the present invention.

FIG. 2 is a flow chart for illustrating how random reproduction or programmed reproduction is performed during normal reproduction in accordance with an embodiment of the present invention.

FIGS. 3A and 3B are diagrams for illustrating a program setting screen.

### DESCRIPTION OF THE PREFERRED EMBODIMENTS

Hereinafter the present invention in an embodiment will more, specifically be described with reference to the drawings. In the figures, identical or like components are identically denoted and their descriptions will not be repeated.

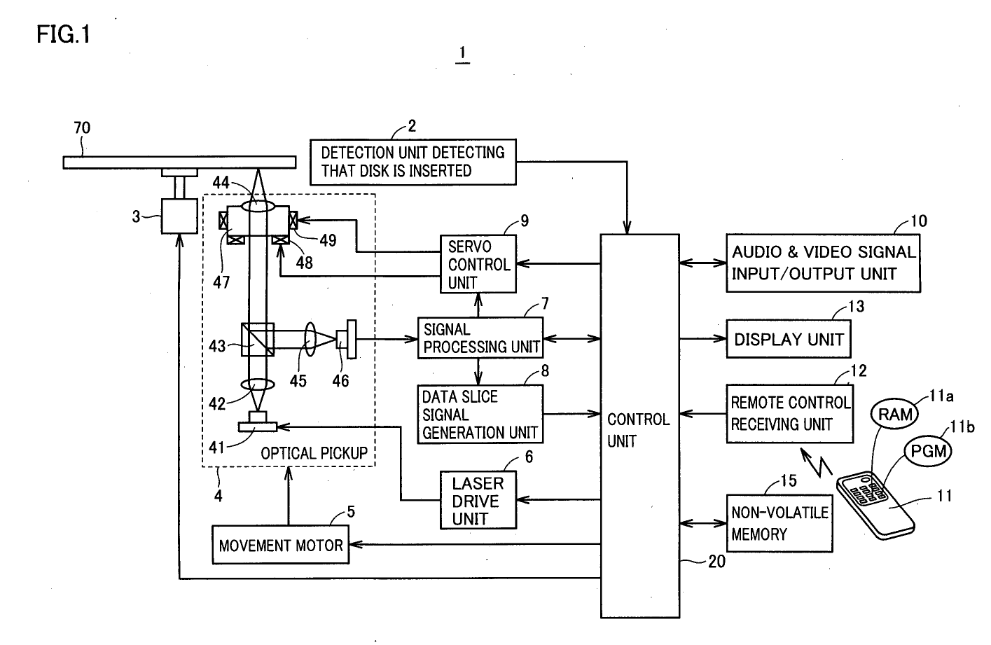

With reference to FIG. 1 the present invention in an embodiment provides an information recording and reproducing apparatus 1 recording music, video images and other similar information on and/or reproducing such information from a CD, a DVD and a similar optical disk 70 having a concentric or spiral information recording track formed therein. Note that in the present embodiment the information recording and reproducing apparatus is assumed to be an information recording and reproducing apparatus capable of recording/reproducing information on/from a CD and a DVD compatibly. Furthermore, in the present embodiment, in particular, the optical disk will hereinafter be described as a CD for example having music information stored therein.

Information recording and reproducing apparatus 1 includes a detection unit 2 detecting that a disk is inserted, a spindle motor 3, an optical pickup 4, a movement motor 5, a laser drive unit 6, a signal processing unit 7, a data slice signal generation unit 8, and a servo control unit (a focusing control unit, a tracking control unit) 9. Furthermore information recording and reproducing apparatus 1 includes an audio and video signal input/output unit 10, a remote controller 11, a remote control receiving unit 12, a display unit 13, a non-volatile memory 15, and a control unit 20 for controlling the above described units.

Detection unit 2 detects that an optical disk is inserted through a disk insertion unit (not shown) and placed on a disk tray, and detection unit 2 accordingly outputs a signal to control unit 20. Note that optical disk 70 inserted is attached to spindle motor 3. Spindle motor 3 is rotatively driven in accordance with an instruction issued from control unit 20 and is thus controlled to rotate the attached optical disk 70 at a predetermined rate.

Optical pickup 4 serves to output light to illuminate optical disk 70 therewith to record and/or reproduce information to and/or from optical disk 70, and also receive a reflection of the light from optical disk 70 and convert it to an electrical signal and output the signal. Optical pickup 4 is moved in accordance with an instruction issued from control unit 20 on optical disk 70 in its radial direction by movement motor 5 implemented by a linear motor.

Optical pickup 4 receives light emanating from a semiconductor laser 41 and collects the light via a collimator lens 42, a beam splitter 43 and an objective lens 44 to illuminate optical disk 70. Furthermore, optical pickup 4 receives a reflection of the light from optical disk 70 via objective lens 44 beam splitter 43 and a condenser lens 45 on a photodetector 46.

Semiconductor laser 41 emits light as controlled by laser drive unit 6, which operates in response to an instruction issued from control unit 20. Photodetector 46 is configured of a divided photodiode that has a photoreceptive surface divided into a plurality of areas and outputs for each photoreceptive surface an electrical signal corresponding to a level in intensity of light received. Photodetector 46 outputs a signal which is in turn input to signal processing unit 7.

Objective lens 44 is held by a lens holder 47 provided with a focusing coil 48 and a tracking coil 49. Focusing coil 48 corporates with a magnet (not shown) to provide a magnetic action to move objective lens 44 in a direction perpendicular to a surface of optical disk 70. Similarly, tracking coil 49 moves objective lens 44 parallel to the surface of optical disk 70 in a direction perpendicular to a recording track of optical disk 70.

Signal processing unit 7 operates as based on a signal output from photodetector 46 to generate an RF signal (intensity of reflection) and outputs the signal to data slice signal generation unit 8, which binarizes the RF signal to generate and input a data slice signal to control unit 20, which detects as based on the data slice signal a pit formed in optical disk 70.

Furthermore, signal processing unit 7 operates as based on a signal output from photodetector 46 to generate a focusing error signal and a tracking error signal and output the signals to servo control unit 9. The focusing error signal is a signal corresponding to an amount of how a point of light gathered via objective lens 44 to illuminate optical disk 70 is offset from the surface of the optical disk. The tracking error signal is a signal corresponding to an amount of how such point is offset from a recording track.

Servo control unit 9 operates in response to the focusing and tracking error signals to provide servo control or control a current supplied to focusing and tracking coils 48 and 49 and thus move objective lens 44 to position the point of the gathered light on the surface of optical disk 70 and on the recording track of the disk.

Audio and video signal input/output unit 10 has a display, a speaker, television, and/or other external device (not shown) connected thereto to output audio and video signals reproduced from optical disk 70 and receive audio and video signals from such external device.

Remote controller 11 is operated to control a variety of types of operations of information recording and reproducing apparatus 1 and has a key to be operated to control the variety of operations. Remote controller 11 operates in response to the key being operated to output a corresponding signal in the form of an infrared signal. Remote control receiving unit 12 receives the infrared signal from remote controller 11 and outputs the signal to control unit 20. Display unit 13 is provided at a front panel of the main body of information recording and reproducing apparatus 1 and displays specifically an operation performed at remote controller 11, how apparatus 1 is operating, and the like.

Note that although not shown, control unit 20 is assumed to have a memory unit having stored therein a control program for performing a variety of types of operations, such as normal reproduction operation, a variety of types of control programs for performing random reproduction or programmed reproduction or similar special reproduction, and/or other programs.

Information is recorded on/reproduced from optical disk 70, as will be described hereinafter. Initially, information is reproduced from optical disk 70, as follows: spindle motor 3 is operated to rotate optical disk 70 at a predetermined rate, while semiconductor laser 41 emits light, which is directed to illuminate optical disk 70, and reflected by the disk and received by photodetector 46. Servo control unit 9 operates as based on a focusing error signal received from signal processing unit 7 to control a current supplied to focusing coil 48 and thus move objective lens 44 to position on the surface of optical disk 70 a point of light output from semiconductor laser 41 and gathered, or focus the light thereon (“focus lock-in”). Furthermore, servo control unit 9 operates in response to a tracking error signal received from signal processing unit 7 to control a current supplied to tracking coil 49 to move objective lens 44 to position such point on a recording track as desired (“track lock-in”).

Thereafter, servo control unit 9 operates in response to focusing and tracking error signals to provide focusing servo control and tracking servo control to control a current supplied to focusing coil 48 and that supplied to tracking coil 49 to keep positioning the point of the gathered light on the disk or focusing the light thereon and positioning such point on the track.

In this servoed condition, signal processing unit 7 outputs an RF signal which is in turn input to data slice signal generation unit 8, which binarizes the RF signal to generate a data slice signal input to control unit 20. Control unit 20 detects as based on the data slice signal the presence/absence of a pit in optical disk 70 to read information recorded on optical disk 70 and reproduce the read information in the form of an audio signal, a video signal or the like and output the signal via audio and video signal input/output unit 10 to an external device.

Furthermore, information is recorded on optical disk 70 by forming a pit on optical disk 70 by light emanating from semiconductor laser 41 with focusing and tracking servo-controlled similarly as described above. At that time, an audio, video and/or similar signal is input from audio and video signal input/output unit 10 and coded by control unit 20 and semiconductor laser 41 is controlled by control unit 20 to emit light in accordance with the coded data. This forms a pit in accordance with the coded data on optical disk 70 at a recording track to record audio, video or similar information. The pit can be formed by causing semiconductor laser 41 to emit light at an output higher than when information is read.

Hereinafter the present embodiment will be described for random reproduction or programmed reproduction or similar special reproduction performed during normal reproduction. As random reproduction and programmed reproduction are common techniques, their reproduction systems will not be described in detail.

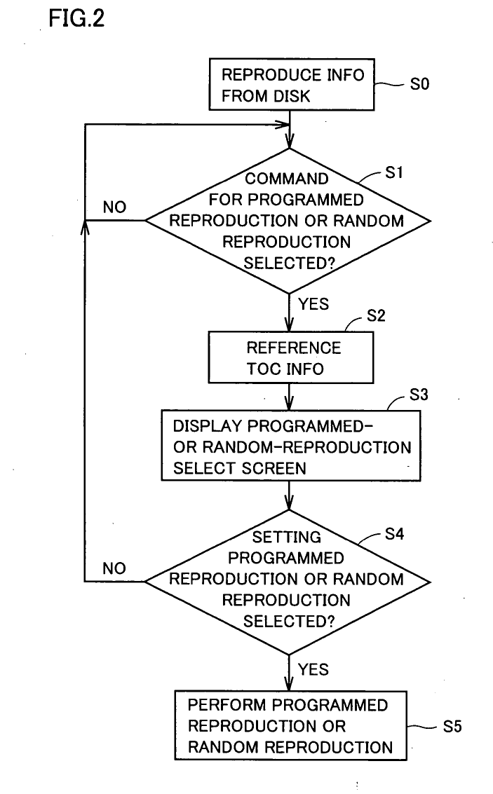

Reference will be made to FIG. 2 to describe how random reproduction or programmed reproduction is performed during normal reproduction in accordance with the present embodiment.

With reference to FIG. 2, a user issues a command and in response thereto a disk is subjected to normal reproduction (step (S) 0). Subsequently, control unit 20 determines whether a command for programmed reproduction or that for random reproduction is selected and indicated (S1). More specifically, control unit 20 determines whether remote controller 11 is operated for example to select (or press) a random-reproduction button (RAM) 11a or a programmed-reproduction button (PGM) 11b shown in FIG. 1. If the button is not selected, S1 is maintained and the normal reproduction is continued.

If the button is selected, then table-of-contents (TOC) information of a lead-in area stored as management information of a CD or optical disk 70 at a radially inner portion is referenced (S2) to obtain an identification number (a track number) of data stored in the CD at a data area.

Subsequently, control unit 20 controls display unit 13 to display a program setting screen stored in the memory unit (S3).

Control unit 20 then determines whether the user selects setting the programmed reproduction or the random reproduction (S4).

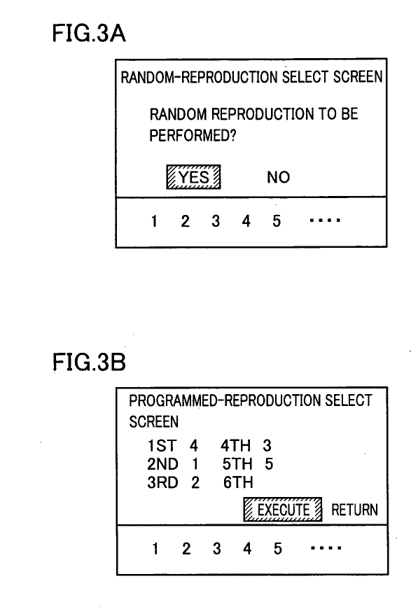

With reference to FIGS. 3A and 3B, the program setting screen will be described.

FIG. 3A is a diagram for illustrating a screen for selection as one example of the program setting screen for performing the random reproduction. As indicated therein, the table-of-contents information is used to display a track number on the screen at a bottom. Furthermore on the screen a cursor is indicated so that in response to the question “random reproduction to be performed?” the user looking at the screen can operate the cursor to select “yes” or “no” as a setting.

FIG. 3B is a diagram for illustrating a screen for selection as one example of the program setting screen for performing the programmed reproduction. As indicated therein, the table-of-contents information is used to display a track number on the screen at a bottom. Furthermore the screen indicates a case in which a user selects as a setting an order of reproduction for example from the track numbers in an order of first to sixth places. In this case, for the first place a track number “4” is selected and for the second place a track number “1” is selected. This selection can be set for example by pressing a numeral key (not shown) of remote controller 11, and an indication is displayed so that for a specific setting made by the user, a cursor key is pointed to “execute” or “return” to make a selection.

Again with reference to FIG. 2 at S4, for example if “execute” is selected in the program setting screen shown in FIGS. 3A and 3B, then control proceeds to S5 and in response to “execute” being selected, as indicated, from the normal reproduction, the programmed reproduction or the random reproduction is performed (S5). More specifically, typically if a CD has music data stored therein, successively a subsequent track is selected in an ascending order to reproduce the music data. In the present configuration, in contrast, the current reproduction is switched to programmed reproduction or random reproduction. For example if programmed reproduction is performed, normal reproduction is stopped, and in an order selected by the user, as programmed by the user, the music data is reproduced by starting to reproduce a track having a track number set as programmed. Furthermore, if random reproduction is performed, a random value selected from a random-number table is selected, and normal reproduction is stopped to start reproducing a track having a track number in accordance with the selected random value.

If at S4 a setting of programmed reproduction or that of random reproduction is not selected, the control return to S1.

Note that for this programmed reproduction or random reproduction an instruction from a user for stopping is not selected: in accordance with specifics selected on a random-reproduction select screen or a programmed-reproduction select screen as shown in FIGS. 3A and 3B, control unit 20 performs the above described, special reproduction.

Thus the present invention in an embodiment provides a configuration that allows an information recording and reproducing apparatus having a special reproduction function added thereto to perform special reproduction, or random reproduction or programmed reproduction, during normal reproduction. This allows a function imparted to equipment to be efficiently utilized to contribute to enhance convenience for users.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information recording and reproducing apparatus comprising:
reproduction means for reproducing data stored in an information storage medium; and
a control unit generally controlling the apparatus, wherein:
said control unit operates in response to a command requesting that said data be reproduced to employ said reproduction means to reproduce data stored in said information storage medium and if during reproduction a command is input requesting that said data be subjected to special reproduction then without receiving a command input requesting that reproduction be stopped said control unit switches to said special reproduction to thus reproduce said data stored in said information storage medium;
said special reproduction is one of programmed reproduction and random reproduction;
said information storage medium is a compact disk; and
in response to said command being received requesting that said special reproduction be performed, said control unit obtains table-of-contents information from said information storage medium.

2. An information recording and reproducing apparatus comprising:
reproduction means for reproducing data stored in an information storage medium; and
a control unit generally controlling the apparatus, wherein
said control unit operates in response to a command requesting that said data be reproduced to employ said reproduction means to reproduce data stored in said information storage medium and if during reproduction a command is input requesting that said data be subjected to special reproduction then without receiving a command input requesting that reproduction be stopped said control unit switches to said special reproduction to thus reproduce said data stored in said information storage medium.

3. The information recording and reproducing apparatus according to claim 2, wherein said special reproduction is one of programmed reproduction and random reproduction.

4. The information recording and reproducing apparatus according to claim 2, wherein said information storage medium is a compact disk.

5. The information recording and reproducing apparatus according to claim 2, wherein in response to said command being received requesting that said special reproduction be performed, said control unit obtains table-of-contents information from said information storage medium.
